(19) United States
(12) Patent Application Publication
(10) Pub. No.: US 2005/0278952 A1
(43) Pub. Date: Dec. 22, 2005

(54) Gear product and method for manufacturing the same

(75) Inventor: Junichi Ooka, Nagoya-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: O-OKA CORPORATION, Aichi (JP)

(21) Appl. No.: 10/511,446

(22) PCT Filed: Apr. 24, 2003
(86) PCT No.: PCT/JP03/05231

§ 371 Date: Jul. 2, 2005

(51) Int. Cl. B23P 15/14; F16H 55/08

(52) U.S. Cl. 29/893; 74/457

(57) ABSTRACT

In a gear product, a plurality of tooth having a crowning formed in a pattern unified to one pattern selected from fourteen patterns comprising four patterns in which a crowning is formed at one of an upper end part A or lower end part B of an upper inclined surface 91, an upper end part C or a lower end part D of a lower inclined surface 92, six patterns in which crownings are formed at two parts thereof and four patterns in which crownings are formed with three parts thereof, are formed at an equal pitch on an outer peripheral surface of a gear part. In a helical gear 9, a combination pattern of an upper part A of an upper side tooth surface 91 and a lower part D of a lower tooth surface 92 or a pair of an upper part C of the lower tooth surface 92 and a lower part D of the upper tooth surface 92 is formed by forging device.

### TECHNICAL FIELD

The present invention relates to a gear product (including a gear with missing teeth) having a plurality of tooth formed at a predetermined pitch on an outer peripheral surface of a disc-form part thereof.

### BACKGROUND ART

Crowning F,F,F,F are formed at four parts of every both end parts of tooth surfaces of tooth form of a gear product so that tooth thickness may gradually decrease from the center part thereof toward both ends of tooth, as shown in FIG. 9 and tooth surfaces engaging each other may always maintain the point contact thereof. A gear product with crowning was manufactured by forming a product having a tooth form without crowning by cutting or forging, and cutting four end parts of tooth surfaces of every tooth so as to form crowning.

In the step of forming crownings at four parts of every tooth by cutting, there were problems that it took a lot of time and trouble, the dispersion of accuracy due to the abrasion of tools and the wastage cost of tools could not be ignored.

In consideration of a purpose of a crowning, there is no problem in function of the crowning as long as crownings are formed on any one of tooth surfaces engaging each other.

Making it possible to produce crownings by forging would be able to enhance efficiency greatly and lower costs.

### DISCLOSURE OF THE INVENTION

It is an object of the present invention to provide a gear product and a method for manufacturing the same, in which by forming a crowning on any one of tooth surfaces engaging each other, it is able to reduce the trouble of process for forming a crowning, to abbreviate machining time, to reduce the dispersion of accuracy due to the abrasion of tools and the wastage cost of tools, to enhance efficiency greatly, and to lower costs.

It is another object of the present invention to reduce a machining time for forming a crowning and to provide a technology for forming a crowning by forging.

The present invention is based on a technical concept that in a gear product having plurality of tooth formed at a predetermined pitch on an outer peripheral surface of a disc-form body thereof, a crowning is formed at least at one end part of a tooth surface of at least one of gears engaging each other.

The present invention (the first invention described in claim 1) provides a gear product having a plurality of tooth profiles formed at a predetermined pitch on an outer peripheral surface of a disc-form body thereof, in which a crowning is formed at least at one end part of a tooth surface of at least one of gears engaging each other.

The present invention (the second invention described in claim 2), according to the first invention, provides a gear product in which the crowning is formed at least at one end part of an upper side tooth surface or a lower side tooth surface of at least one or the other gear.

The present invention (the third invention described in claim 3), according to the first invention, provides a gear product in which the crowning is formed at two end parts arbitrarily selected from four end parts of both of an upper side tooth surface and a lower side tooth surface of one or the other gear.

The present invention (the fourth invention described in claim 4), according to the first invention, provides a gear product in which the crowning is formed at three end parts arbitrarily selected from four end parts of both of an upper side tooth surface and a lower side tooth surface of one or the other gear.

The present invention (the fifth invention described in claim 5), according to the first invention, provides a gear product in which the crowning is formed at an upper end part of an upper side tooth surface of one gear and the crowning is formed at the upper end part and a lower end part of the upper side tooth surface and a lower end part of a lower side tooth surface of the other gear.

The present invention (the sixth invention described in claim 6), according to the first invention, provides a gear product in which the crowning is formed at upper and lower end parts of an upper side tooth surface and an upper end part of a lower side tooth surface of one gear, and the crowning is formed at the upper and lower end parts of the upper side tooth surface and a lower end part of the lower side tooth surface of the other gear.

The present invention (the seventh invention described in claim 7), according to the first invention, provides a gear product in which the crowning is formed at an upper end part of an upper side tooth surface and a lower end part of a lower side tooth surface of one gear.

The present invention (the eighth invention described in claim 8), according to the first invention, provides a gear product in which the crowning is formed at upper and lower end parts of an upper side tooth surface and a lower end part of a lower side tooth surface of one gear and the crowning is formed at the upper end part of the upper side tooth surface and the lower end part of the lower side tooth surface of the other gear.

The present invention (the ninth invention described in claim 9), according to the first invention, provides a gear product in which the crowning is formed at a lower end part of an upper side tooth surface and an upper end part of a lower side tooth surface of one gear.

The present invention (the tenth invention described in claim 10), according to the first invention, provides a gear product in which the crowning is formed at a lower end part of an upper side tooth surface and an upper end part of a lower side tooth surface of one gear and the crowning is formed at the lower end part of the upper side tooth surface and the upper end part of the lower side tooth surface of the other gear.

The present invention (the eleventh invention described in claim 11) provides a technology which enables to reduce machining time for forming a crowning and a technology for forming a crowning by the utilization of forging means, and provides a gear product having a plurality of tooth formed at a predetermined pitch on an outer peripheral surface of a disc-form body thereof, in which tooth forms of all teeth are unified to one pattern selected from a plurality of pattern in which a crowning is formed at at least one of four parts of every both ends on each tooth surface of the teeth and the crowning is not formed at the other of the four parts thereof.

The present invention (the twelfth invention described in claim 12), according to the eleventh invention, provides a gear product in which the selected pattern is one of fourteen patterns comprising four patterns in which the crowning is formed at one of an upper end part or lower end part of a upper inclined surface, and an upper end part or a lower end part of a lower inclined surface, six patterns in which the crownings are formed at two parts such as the upper end part and the lower end part of the upper inclined surface, the upper end part of the upper inclined surface and the upper end part of the lower inclined surface, the upper end part of the upper inclined surface and the lower end part of the lower inclined surface, the lower end part of the upper inclined surface and the upper end part of the lower inclined surface, the lower end part of the upper inclined surface and the lower end part of the lower inclined surface, or the upper end part and lower end part of the lower inclined surface, and four patterns in which the crownings are formed at three parts such as the upper end part and the lower end part of the upper inclined surface and the upper end part of the lower inclined surface, the upper end part and the lower end part of the upper inclined surface and the lower end part of the lower inclined surface, the upper end part of the upper inclined surface and the upper end part and the lower end part of the lower inclined surface, or the lower end part of the upper inclined surface and the upper end part and the lower end part of the lower inclined surface.

The present invention (the thirteenth invention described in claim 13), according to any one of the inventions from the first to the twelfth, provides a gear product in which the plurality of tooth formed on the outer peripheral surface of the disc-form part thereof is a helical tooth.

The present invention (the fourteenth invention described in claim 14) provides a method for manufacturing a gear product having a plurality of tooth formed at a predetermined pitch on an outer peripheral surface of a disc-form body thereof, in which a crowning is formed at least at one end part of tooth surface of at least one of gears engaging each other.

The present invention (the fifteenth invention described in claim 15), according to the fourteenth invention, provides a method for manufacturing a gear product in which a tooth form having the crowning of a tooth formed on the outer peripheral surface is formed by cutting.

The present invention (the sixteenth invention described in claim 16), according to the fourteenth invention, provides a method for manufacturing a gear product in which a tooth form having the crowning of a helical tooth formed on the outer peripheral surface is formed by upsetting on forging.

The present invention (the seventeenth invention described in claim 17), according to the fourteenth invention, provides a method for manufacturing a gear product in which a tooth form having the crowning of a helical tooth formed on the outer peripheral surface is formed by ironing on forging.

The present invention (the eighteenth invention described in claim 18) provides a method for manufacturing a gear product in which a first molding having a plurality of tooth, having no crowning, formed at a predetermined pitch on an outer peripheral surface of a disc-form body thereof is cut so that tooth forms of all teeth may be unified to a pattern selected from a plurality of pattern in which the crowning is formed at at least one of four parts of every both ends on each tooth surface of the teeth and the crowning is not formed at the other of the four parts thereof.

The present invention (the nineteenth invention described in claim 19) provides a method for manufacturing a gear product in which a first molding having a plurality of helical tooth, having no crowning, formed at a predetermined pitch on an outer peripheral surface of a disc-form body thereof is molded by upsetting so that the crowning can be formed at an upper part of an upper side tooth surface and a lower part of a lower side tooth surface among four parts of both ends parts of tooth surfaces of the all teeth.

The present invention (the twentieth invention described in claim 20) provides a method for manufacturing a gear product in which a first molding having a plurality of helical tooth, having no crowning, formed at a predetermined pitch on an outer peripheral surface of a disc-form body thereof is molded by ironing so that the crowning may be formed at a lower part of an upper side tooth surface and an upper part of a lower side tooth surface among four parts of both end parts of tooth surfaces of the all teeth.

The present invention achieves rationalization by decreasing at least one cutting part in case that the crowning is formed by cutting.

Moreover, in case that the crowning is formed by forging, the present invention has an advantage that there is no need of cutting, it is efficient and there is no dispersion.

### BRIEF DESCRIPTION OF THE DRAWINGS

FIG. 1 is an explanation diagram showing a step for forming the first molded article in the manufacturing method according to the present invention;

FIG. 2 is an explanation diagram showing the first molded article;

FIG. 3 is an explanation diagram showing patterns of a crowning formed by cutting process;

FIG. 4 is an explanation diagram showing examples of gears engaging each other;

FIG. 5 is an explanation diagram showing an example of forming crownings in upsetting process;

FIG. 6 is an explanation diagram showing a combination of gears formed in upsetting process;

FIG. 7 is an explanation diagram showing an example of forming a crowning in ironing process;

FIG. 8 is an explanation diagram showing a combination of gears formed in ironing process; and

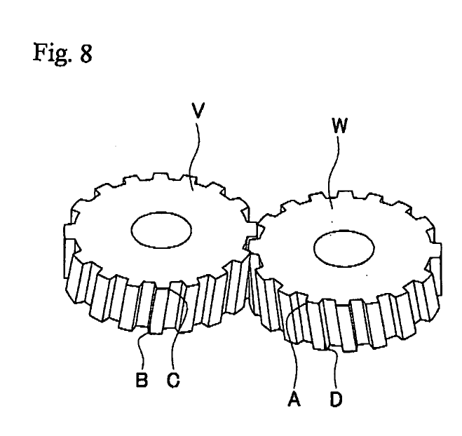

FIG. 9 is an explanation diagram showing a conventional pattern of forming crownings.

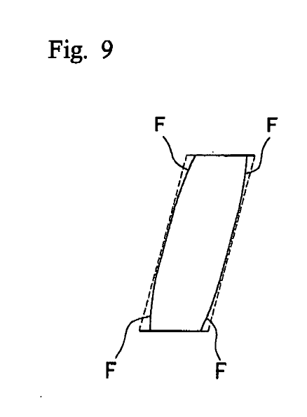

### BEST MODE FOR CARRYING OUT THE INVENTION

A gear product and a method for manufacturing the same according to the present invention will now be described with reference to the drawings.

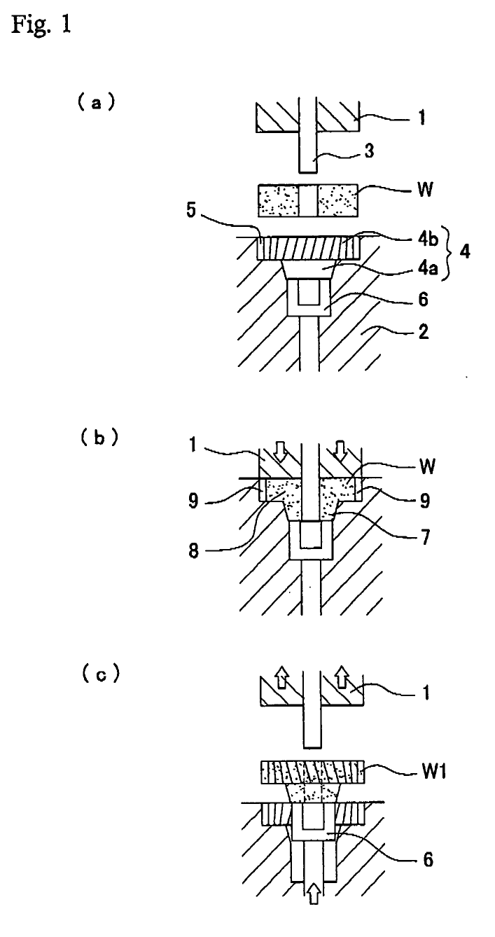

FIG. 1 shows a forming step of the first molded article. In FIG. 1, 1 is a cope, 2 is a drag and a mandrel 3 is projected at the center of a pressure surface of the cope 1.

Meanwhile, a cavity 4, which is two-stage form composed of a disc-form like boss forming part 4a for forming a boss and a disc-form gear forming part 4b for forming a gear, is provided in the drag 2. A tooth form or profile 5 for forming helical gear is formed on an inner peripheral surface corresponding to the gear forming part 4b and a knockout sleeve 6 is provided on a bottom surface so as to project movably.

When a disc-form work W set at an opening of the cavity 4 is depressed by the cope 1 (as shown in FIG. 1(b)), the work W is compressed into the cavity 4, the cavity 4 is filled with the work W, a boss part 7 is formed at the bottom surface by extrusion and a helical tooth 9 is formed on an outer peripheral surface of a disc-form gear part 8 having an axial hole.

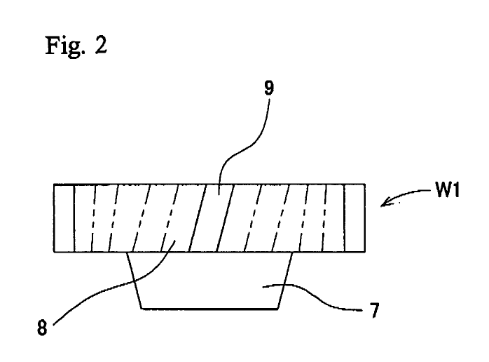

When the cope 1 is send up so as to release the pressure, a first molded article W1 shown in FIG. 2 can be took out by push up of the knockout sleeve 6.

The helical tooth 9 of the first molded article W1 molded in this process has no crowning.

Then, a crowning is formed in the second process.

There are three methods for forming a crowning. In the first, one of them is a cutting process.

The cutting process is the same as a conventional cutting process with cutting tools.

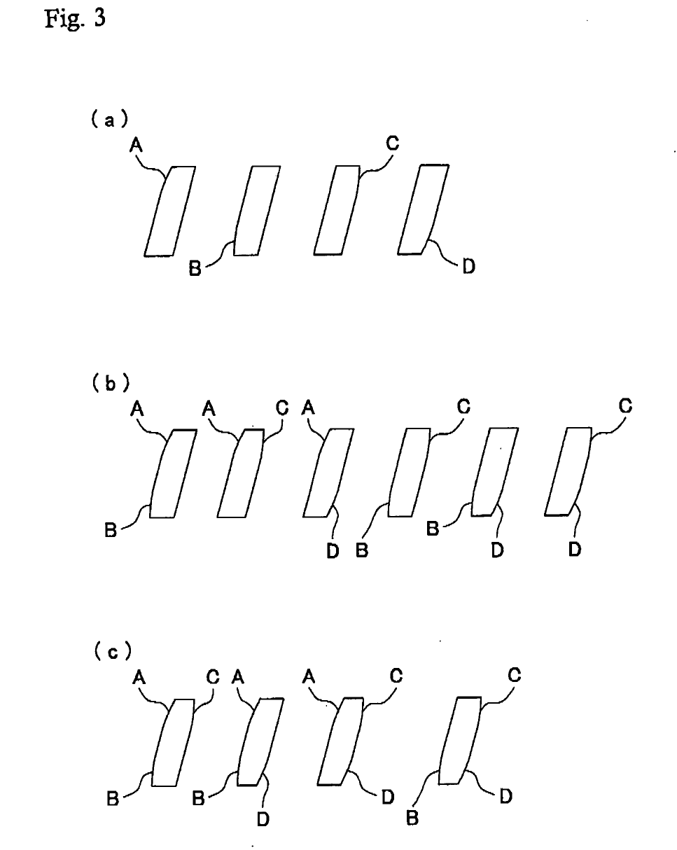

However, cut parts are not all of the four parts of both end parts on tooth surfaces and a crowning is formed in one pattern selected from fourteen patterns. The fourteen patterns comprise four patterns in which the crowning is formed at one of an upper end part A or a lower end part B of an upper inclined surface 91, an upper end part C or a lower end part D of a lower inclined surface 92 (as shown in FIG. 3(a)); six patterns in which crownings are formed at two parts such as the upper end part A and the lower end part B of the upper inclined surface 91, the upper end part A of the upper inclined surface 91 and the upper end part C of the lower inclined surface 92, the upper end part A of the upper inclined surface 91 and the lower end part D of the lower inclined surface 92, the lower end part B of the upper inclined surface 91 and the upper end part C of the lower inclined surface 92, the lower end part B of the upper inclined surface 91 and the lower end part D of the lower inclined surface 92, or the upper end part C and the lower end part D of the lower inclined surface 92 (as shown in FIG. 3(b)); and four patterns in which crownings are formed at three parts such as the upper end part A and the lower end part B of the upper inclined surface 91 and the upper end part C of the lower inclined surface 92, the upper end part A and the lower end part B of the upper inclined surface 91 and the lower end part D of the lower inclined surface 92, the upper end part A of the upper inclined surface 91 and the upper end part C and the lower end part D of the lower inclined surface 92, or the lower end part B of the upper inclined surface 91 and the upper end part C and the lower end part D of the lower inclined surface 92 (as shown in FIG. 3(c)).

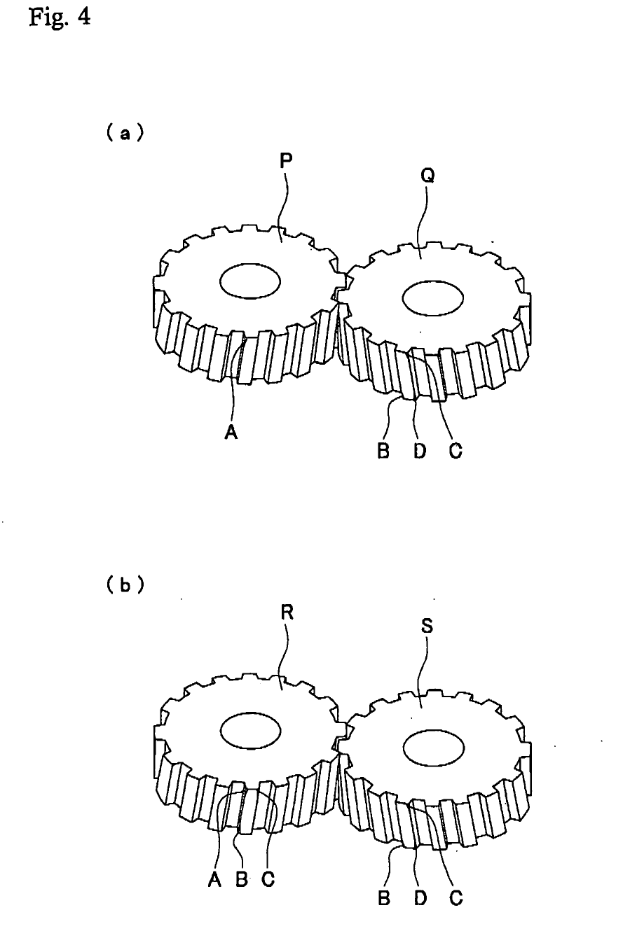

In the gear products formed in the above described manner, there is no problem in function of a crowning as long as a crowning is formed on at least one tooth surface of gears engaging each other such as a gear P having a crowning formed at the upper end part A of the upper inclined surface 91 and a gear Q having crownings formed at the lower end part B of the lower inclined surface 92 and the upper end part C and lower end part D of the upper inclined surface 91 (since a inclination of a tooth on the gear Q is reverse relation to that of a tooth on the gear P and the upper inclined surface 91 of the gear P is engaged with the lower inclined surface 92 of the gear Q, the responding symbol is used to the engaged part of the gear Q which is engaged with that of the gear G), as shown in FIG. 4(a).

Moreover, for example, in the combination of a gear R on which crownings are formed at the upper end part A and the lower end part B of the upper inclined surface 91 and the upper end part C of the lower inclined surface 92, and a gear S on which crownings are formed at the lower end part B of the lower inclined surface 92 and the upper end part C and the lower end part D of the upper inclined surface 91 (as shown in FIG. 4(b)), there is no problem when crownings are redundantly formed at the corresponding parts respectively such as the lower end part B of the upper inclined surface 91 and the upper end part C of the lower inclined surface 92 on the gear R and the lower end part B of the lower inclined surface 92 and the upper end part C of the upper inclined surface 91 on the gear S. It is proper that the crowning is formed on at least one part of engaged part for engaging the other on the combination of gears.

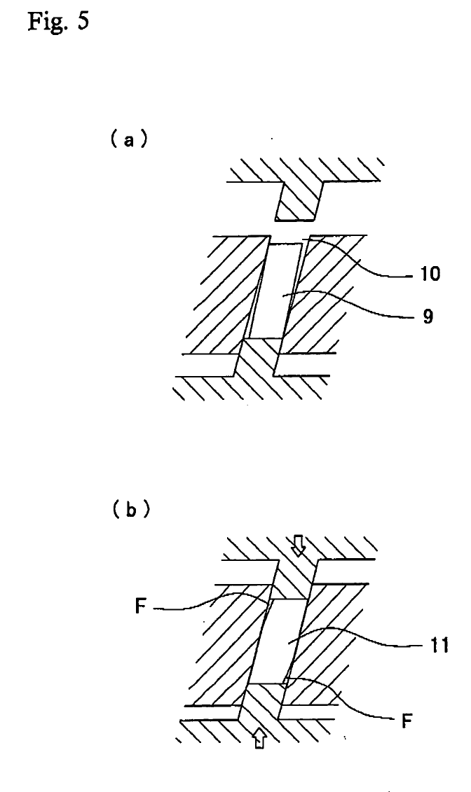

In the second method of the three methods for manufacturing a crowning, a crowning is formed by upsetting process as a forging process, In this upsetting process, as shown in FIG. 5(a) and FIG. 5(b), a helical tooth 9 is depressed in an axial direction in a die 10 for forming a helical tooth. When the helical tooth 9 is depressed, a lower part of an upper side surface 91 and an upper part of a lower side surface 92 are strongly depressed on an inner surface of the die 10 for forming a helical tooth.

Meanwhile, an upper part of the upper side tooth surface 91 and a lower part of the lower side tooth surface 92 are weakly depressed and the upper part of the upper side tooth surface 91 and a lower part of the lower side tooth surface 92 are stretched toward inside thereof.

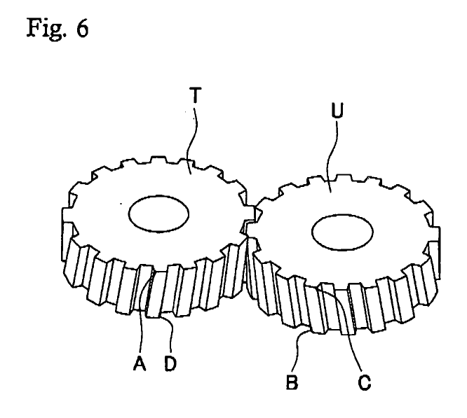

Therefore, crownings are formed at the upper part A of the upper side tooth surface 111 and the lower part D of the lower side tooth surface 112 of a helical tooth 11 of the gear shown in FIG. 5(b) and the gear T shown in FIG. 6.

In this way, crownings formed by upsetting process are formed at parts having left-to-right inverted relationship determined by an inclined direction of a helical tooth. Therefore, in a pair of the gear T and a gear U having crownings formed in reverse patterns with each other, crownings are formed at all of four parts A,B,C,D of a meshing surface of any teeth.

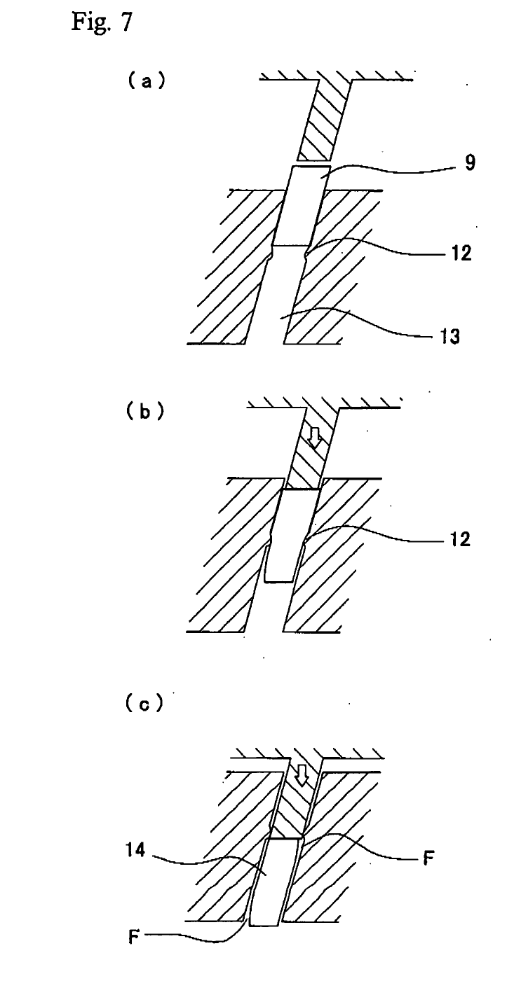

In the ironing process as one of remaining forging processes, a helical tooth 9 is ironed along a tooth trace by putting the helical tooth 9 through a die 13 for forming a helical tooth having constrictions formed on an inner surface thereof, as shown in FIGS. 7(a)-(c).

Crownings F,F are formed at a lower part of an upper side tooth surface 141 and the upper part of the lower side tooth surface 142 of a helical tooth 14 by ironing.

In this way, crownings formed by ironing process also are formed at parts having left-to-right inverted relationship determined by an inclined direction of a helical tooth. Therefore, in a pair of the gear V and a gear W having crownings formed in reverse patterns with each other, crownings are formed at all four parts A,B,C,D of a meshing surface of any teeth.

When the crowning is formed in upsetting and ironing process as one of forging processes, there is no need of cutting process, the crowning is formed instantly and there is no dispersion.

By the way, in a case that a crowning is formed by cutting, crownings can be formed at any other tooth form except for a helical tooth.

Moreover, there is no problem in finishing a crowning formed by forging process so as to raise the accuracy of the crowning.

In all gear products manufactured by these forging processes, when one crowning of both side tooth surface in tooth trace direction is formed at an upper end part of one side tooth surface, the other crowning thereof is formed at an lower end part of the other side tooth surface. Meanwhile, on cutting process, the crownings can be formed on all patterns shown in FIG. 3 and in result, the number of the cut parts is less than the number of cut parts in a conventional cutting process.

Moreover, it is able to achieve rationalization by the combination of forging and cutting.

The preferred embodiments of the present invention, as herein disclosed, are taken as some embodiments for explaining the present invention. It is to be understood that the present invention should not be restricted by these embodiments and any modifications and additions are possible so far as they are not beyond the technical idea or principle based on descriptions of the scope of the patent claims.

### INDUSTRIAL APPLICABILITY

In a gear product having a plurality of tooth formed at a predetermined pitch on an outer peripheral surface of a disc-form body thereof and a method for manufacturing the same, by forming a crowning at least at one end part of a tooth surface of at least one of gears engaging each other, it is able to reduce the trouble of process for forming a crowning, to abbreviate machining time, to reduce the dispersion of accuracy due to abrasion of tools and the wastage cost of tools, to enhance efficiency greatly, and to lower costs.

1. A gear product having a plurality of tooth formed at a predetermined pitch on an outer peripheral surface of a disc-form body thereof, wherein
a crowning is formed at least at one end part of a tooth surface of at least one of gears engaging each other.

2. A gear product according to claim 1, wherein said crowning is formed at least at one end part of an upper side tooth surface or a lower side tooth surface of at least one or the other gear.

3. A gear product according to claim 1, wherein
said crowning is formed at two end parts arbitrarily selected from four end parts of both of an upper side tooth surface and a lower side tooth surface of one or the other gear.

4. A gear product according to claim 1, wherein
said crowning is formed at three end parts arbitrarily selected from four end parts of both of an upper side tooth surface and a lower side tooth surface of one or the other gear.

5. A gear product according to claim 1, wherein
said crowning is formed at an upper end part of an upper side tooth surface of one gear and
said crowning is formed at said upper end part and a lower end part of said upper side tooth surface and a lower end part of a lower side tooth surface of the other gear.

6. A gear product according to claim 1, wherein
said crowning is formed at upper and lower end parts of an upper side tooth surface and an upper end part of a lower side tooth surface of one gear, and
said crowning is formed at said upper and lower end parts of said upper side tooth surface and a lower end part of said lower side tooth surface of the other gear.

7. A gear product according to claim 1, wherein
said crowning is formed at an upper end part of an upper side tooth surface and a lower end part of a lower side tooth surface of one gear.

8. A gear product according to claim 1, wherein
said crowning is formed at upper and lower end parts of an upper side tooth surface and a lower end part of a lower side tooth surface of one gear and
said crowning is formed at said upper end part of said upper side tooth surface and said lower end part of said lower side tooth surface of the other gear.

9. A gear product according to claim 1, wherein
said crowning is formed at a lower end part of an upper side tooth surface and an upper end part of a lower side tooth surface of one gear.

10. A gear product according to claim 1, wherein
said crowning is formed at a lower end part of an upper side tooth surface and an upper end part of a lower side tooth surface of one gear and
said crowning is formed at said lower end part of said upper side tooth surface and said upper end part of said lower side tooth surface of the other gear.

11. A gear product having a plurality of tooth formed at a predetermined pitch on an outer peripheral surface of a disc-form body thereof, wherein
tooth forms of all teeth are unified to one pattern selected from a plurality of pattern in which a crowning is formed at at least one of four parts of every both ends on each tooth surface of said teeth and said crowning is not formed at the other of said four parts thereof.

12. A gear product according to claim 11, wherein
said selected pattern is one of fourteen patterns comprising four patterns in which said crowning is formed at one of an upper end part or lower end part of an upper inclined surface, and an upper end part or a lower end part of a lower inclined surface,
six patterns in which said crownings are formed at two parts such as said upper end part and said lower end part of said upper inclined surface, said upper end part of said upper inclined surface and said upper end part of said lower inclined surface, said upper end part of said upper inclined surface and said lower end part of said lower inclined surface, said lower end part of said upper inclined surface and said upper end part of said lower inclined surface, said lower end part of said upper inclined surface and said lower end part of said lower inclined surface, or said upper end part and lower end part of said lower inclined surface, and
four patterns in which said crownings are formed at three parts such as said upper end part and said lower end part of said upper inclined surface and said upper end part of said lower inclined surface, said upper end part and said lower end part of said upper inclined surface and said lower end part of said lower inclined surface, said upper end part of said upper inclined surface and said upper end part and said lower end part of said lower inclined surface, or said lower end part of said upper inclined surface and said upper end part and said lower end part of said lower inclined surface.

13. A gear product according to any one of claims 1-12, wherein
said plurality of tooth formed on said outer peripheral surface of said disc-form part thereof is a helical tooth.

14. A method for manufacturing a gear product having a plurality of tooth formed at a predetermined pitch on an outer peripheral surface of a disc-form body thereof, wherein
a crowning is formed at least at one end part of tooth surface of at least one of gears engaging each other.

15. A method for manufacturing a gear product according to claim 14, wherein
a tooth form having said crowning of a tooth formed on said outer peripheral surface is formed by cutting.

16. A method for manufacturing a gear product according to claim 14, wherein
a tooth form having said crowning of a helical tooth formed on said outer peripheral surface is formed by upsetting on forging.

17. A method for manufacturing a gear product according to claim 14, wherein
a tooth form having said crowning of a helical tooth formed on said outer peripheral surface is formed by ironing on forging.

18. A method for manufacturing a gear product, wherein
a first molding having a plurality of tooth, having no crowning, formed at a predetermined pitch on an outer peripheral surface of a disc-form body thereof is cut so that tooth forms of all teeth may be unified to a pattern selected from a plurality of pattern in which said crowning is formed at at least one of four parts of every both ends on each tooth surface of said teeth and said crowning is not formed at the other of said four parts thereof.

19. A method for manufacturing a gear product, wherein
a first molding having a plurality of helical tooth, having no crowning, formed at a predetermined pitch on an outer peripheral surface of a disc-form body thereof is molded by upsetting so that said crowning can be formed at an upper part of an upper side tooth surface and a lower part of a lower side tooth surface among four parts of both ends parts of tooth surfaces of said all teeth.

20. A method for manufacturing a gear product, wherein
a first molding having a plurality of helical tooth, having no crowning, formed at a predetermined pitch on an outer peripheral surface of a disc-form body thereof is molded by ironing so that said crowning may be formed at a lower part of an upper side tooth surface and an upper part of a lower side tooth surface among four parts of both end parts of tooth surfaces of said all teeth.
